(19) United States
(12) Patent Application Publication
(10) Pub. No.: US 2009/0122733 A1
(43) Pub. Date: May 14, 2009

(54) Coordinator in wireless sensor network and method of operating the coordinator

(75) Inventors: Jae Hong Ruy, Daejeon-city (KR); Jong Suk Chae, Daejeon-city (KR); Cheol Sig Pyo, Daejeon-city (KR); Bong Soo Kim, Daejeon-city (KR); Dong Wong Kim, Daejeon-city (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Deajeon (KR)

(21) Appl. No.: 12/153,893

(22) Filed: May 27, 2008

(30) Foreign Application Priority Data
Nov. 9, 2007 (KR) 10-2007-0114195

(51) Int. Cl. H04L 12/56

(52) U.S. Cl. 370/310

(57) ABSTRACT

Provided are a coordinator in a wireless sensor network (WSN) which can improve transmission performance and prevent data loss, and a method of operating the coordinator. The method includes: scanning a transmitted beacon and storing information on a channel included in the beacon; when it is determined that a home channel communicating with a parent node is in an inactive mode on the basis of the information on the channel, in synchronization with the activation of another channel of the same hierarchical level as that of the home channel, activating a home channel communicating with a child node and communicating with the child node; and communicating with the child node through an auxiliary channel that has a frequency band different from those of the home channel communicating with the child node and home channels of other nodes and is always in an active mode.

### CROSS-REFERENCE TO RELATED PATENT APPLICATION

This application claims the benefit of Korean Patent Application No. 10-2007-0114195, filed on Nov. 9, 2007, in the Korean Intellectual Property Office, the disclosure of which is incorporated herein in its entirety by reference.

### BACKGROUND OF THE INVENTION

1. Field of the Invention

The present invention relates to a wireless sensor network (WSN), and more particularly, to a method and apparatus for operating two or more channels by using two radio interfaces.

2. Description of the Related Art

Wireless sensor networks (WSNs) are being actively researched in various fields such as environment monitoring, medical systems, and robot exploration. Such WSNs are multi-hop networks formed by a plurality of distributed autonomous nodes. Each of the nodes includes a plurality of sensors, an embedded processor, and a low power radio, and is battery powered. Typically, such nodes cooperate with one another to perform a common task.

Media access control (MAC) is an important technique that enables the successful operation of a network such as a shared-medium communications network. The purpose of the MAC is to prevent two or more nodes from transmitting data at the same time and causing collisions. Many MAC protocols have been developed for wireless audio or data networks such as time division multiple access (TDMA), code division multiple access (CDMA), and contention-based institute of electrical and electronics engineers (IEEE) 802.11.

In designing a good MAC protocol for a WSN, energy efficiency is one of the most important requirements. Sensor nodes are battery powered as described above, and it is difficult to replace such batteries. With diminishing manufacturing costs, the sensor nodes may be thrown away rather than replacing their batteries when the sensor nodes are used up. Accordingly, it is very important to prolong the life span of the WSN consisting of such sensor nodes.

Another important requirement is scalability to a change in network size, node density, and topology. Network topology is changed over time for many reasons, and the good MAC protocol should have scalability to handle the changed network topology. Thus, ZigBee and sensor MAC (SMAC) have been researched and used considering the above requirements, and have been modified.

While research on WSNs has been focused primarily on energy efficiency and scalability, there has been few research conducted on throughput and reliability.

Dedicated control channel (2 Radios), common hopping sequence, split phase, and concurrency rendezvous protocols have recently been suggested to obtain a high speed broadband in a wireless local area network (WLAN) standard such as IEEE802.11. However, since the protocols are based on IEEE802.11 WLAN, the protocols cannot be applied to WSNs for the following reasons. In a WSN, only one radio interface is generally used to reduce power consumption. Also, since traffic is very small, a duty cycle of sensor nodes is very low (95% or more). That is, the sensor nodes turn off their radios for most of the time in a sleep mode, and wake up regularly to communicate during an active period. In other words, the sensor nodes in the WSN operate in a beacon-based power saving mode. Also, traffic congestion may appear in a gateway direction in the WSN. Also, when multi-hop networks are used, a traffic control method of transmitting urgent information is necessary.

FIG. 1 illustrates a conventional WSN 150.

Referring to FIG. 1, sensor nodes 170 through 174 interwork with a server 105 connected to a wired Internet backbone network 101. In the conventional WSN 150, downstream traffic flows from a gateway (GW) 160 to all the sensor nodes 170 through 174 and upstream traffic flows from all the sensor nodes 170 through 174 to the GW 160.

In the downstream traffic, even when traffic congestion occurs, data loss can be prevented if the GW 160 has a sufficient buffer that may be sufficient when the GW 160 is connected to the wired Internet backbone network 101, and is smoothly supplied with power.

However, since the sensor nodes 170 through 174 are battery powered and thus meaning that low power consumption is very important, the sensor nodes 170 through 174 are required to have a small buffer space, and minimize interface operations. Accordingly, in the upstream traffic, unless data is instantly transmitted, a buffer may overflow at the sensor nodes 170 and 171 acting as coordinators during periods of heavy traffic, thereby causing data loss.

### SUMMARY OF THE INVENTION

The present invention provides a coordinator in a wireless sensor network (WSN), which can operate at low power, improve transmission performance, and prevent data loss, and a method of operating the coordinator.

According to an aspect of the present invention, there is provided a coordinator in a wireless sensor network (WSN), the coordinator comprising: a scan unit scanning a transmitted beacon and storing information on a channel included in the beacon; a main radio interface communication unit, when it is determined that a home channel communicating with a parent node is in an inactive mode on the basis of the information on the channel, in synchronization with the activation of another channel of the same hierarchical level as that of the home channel, activating a home channel communicating with a child node, and communicating with the child node; and an auxiliary radio interface communication unit communicating with the child node through an auxiliary channel that has a frequency band different from frequency bands of the home channel communicating with the child node and home channels of other nodes, and is always in an active mode.

According to another aspect of the present invention, there is provided a method of operating a coordinator in a WSN, the method comprising: scanning a transmitted beacon and storing information on a channel included in the beacon; when it is determined that a home channel communicating with a parent node is in an inactive mode on the basis of the information on the channel, in synchronization with the activation of another channel of the same hierarchical level as that of the home channel, activating a home channel communicating with a child node, and communicating with the child node; and communicating with the child node through an auxiliary channel that has a frequency band different from those of the home channel communicating with the child node and home channels of other nodes and is always in an active mode.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional wireless sensor network (WSN);

FIG. 2 illustrates a WSN according to an embodiment of the present invention;

FIG. 3 illustrates a beacon frame according to an embodiment of the present invention;

FIG. 4 is a flowchart illustrating a structure of a beacon in each channel, data types, such as Beacon, Data, or Ack, in an activated channel, and operations of multi-channels, according to an embodiment of the present invention;

FIG. 5 is a flowchart illustrating operations of multi-channels according to an embodiment of the present invention;

FIG. 6 is a flowchart illustrating operations of multi-channels according to another embodiment of the present invention;

FIG. 7 is a flowchart illustrating operations of multi-channels according to another embodiment of the present invention;

FIG. 8 is a flowchart illustrating operations of multi-channels according to another embodiment of the present invention;

FIG. 9 is a flowchart illustrating operations of multi-channels according to another embodiment of the present invention; and

FIG. 10 is a flowchart illustrating operations of multi-channels according to another embodiment of the present invention;

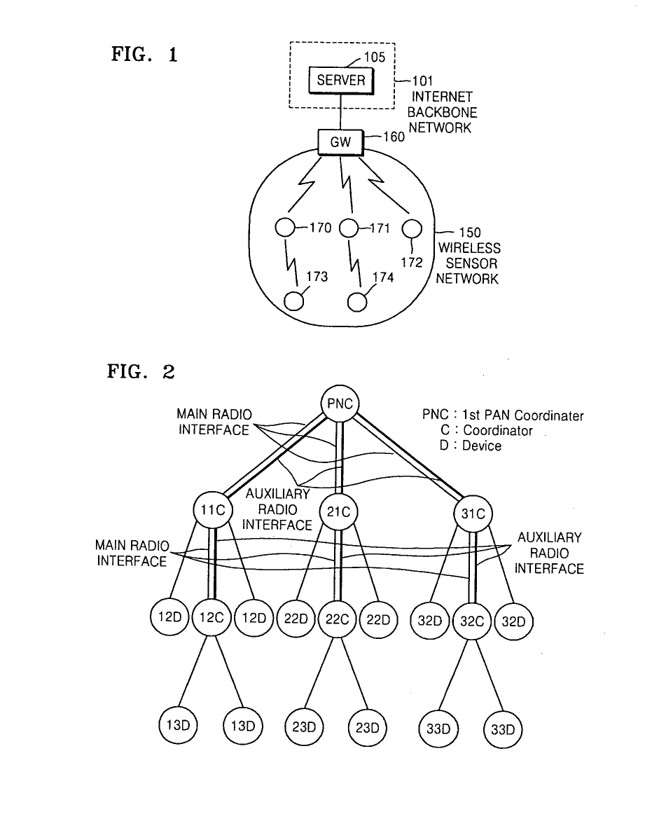

### DETAILED DESCRIPTION OF THE INVENTION

The present invention will now be described more fully with reference to the accompanying drawings, in which exemplary embodiments of the invention are shown.

Channels and a personal area network (PAN), a beacon frame, a scan procedure, and operations of multi-channels will be sequentially explained.

1. Channels and a PAN

FIG. 2 illustrates a wireless sensor network (WSN) according to an embodiment of the present invention.

Referring to FIG. 2, all nodes have a single radio interface. Piconet coordinator (PNC) full function device (FFD) acts as a first PAN coordinator, C(FFD) acts as a coordinator, and D(FFD) or reduced function device (RFD) acts as a device.

The Zigbee standard supports 16 channels in a 2.45 GHz band and 10 channels in a 915 MHz band. A PAN is configured and operates such that a coordinator selects one channel and periodically transmits beacons through the selected channel, and devices in a coverage area sensing the transmitted beacons join. Also, several PANs working on different channels in the coverage area may overlap.

The PAN may be extended like a peer-to-peer cluster tree structure. A node 11C has a first channel as a home channel, a node 21C has a second channel as a home channel, and a node 31C has a third channel as a home channel, each forming a cluster tree structure. The PNC operates by activating one of the first, second, and third channels according to time slots.

2. Beacon Frame

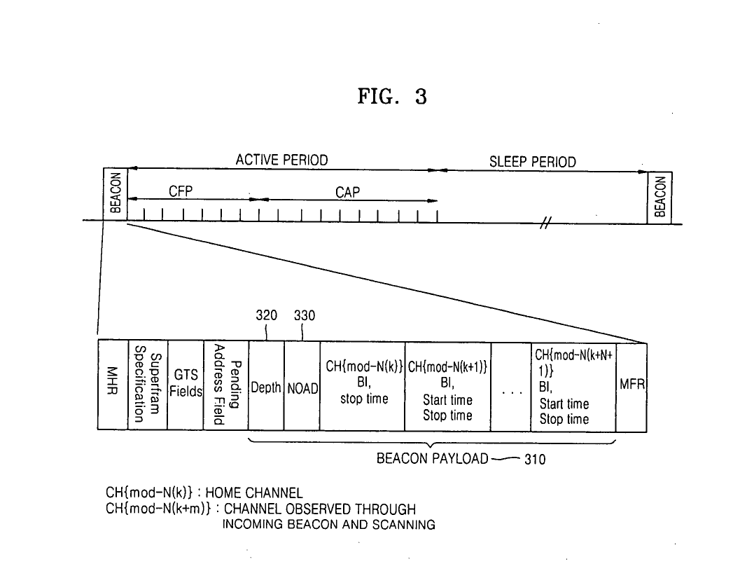

FIG. 3 illustrates a beacon frame according to an embodiment of the present invention.

Referring to FIG. 3, included in a beacon frame generated and transmitted by a PNC or a coordinator, a payload field 310, which can be defined and used by a user, contains superframe schedule information, such as a beacon interval (BI) or a stop time, of a current channel and schedule information, such as BIs, start times, or stop times, of other channels.

Devices FFD and RFD recognize the coordinator transmitting the beacon and channel information through scanning. The payload field 310 includes a depth field 320 indicating a distance of the coordinator transmitting the beacon from a root node, and a number of associated device (NOAD) field 330 indicating the number of currently joining devices in order to help to select a parent node desiring to join.

3. Scan Procedure

The devices FFD and RFD manage schedule information of each channel by generating a channel descriptor during a scan procedure. The devices FFD and RFD manage channel information of PANs using the same first PAN coordinator identification (ID), that is, the same gateway (GW). In detail, the devices FFD and RFD manage a start time and a duration of an auxiliary channel as relative time information to a schedule of a home channel.

4. Operations of Multi-Channels

In order to explain operations of multi-channels, an operation of a home channel, an operation of an auxiliary channel when one radio interface is used, and an operation of an auxiliary channel when two radio interfaces are used will be sequentially explained. An operation of a home channel when a main radio interface from among two radio interfaces is used and an operation of an auxiliary channel when one radio interface is used will be first explained.

(1) Operation of Home Channel

A coordinator joins as a child of two parent coordinators using different channels, and uses one channel as a home channel to belong to one PAN, and uses the other channel as an auxiliary channel. When the coordinator has upstream data that needs to be urgently transmitted, since the coordinator can know an activation start time of the auxiliary channel, the coordinator can change the channel and can transmit the data. A device RFD belongs to one PAN through one home channel in general.

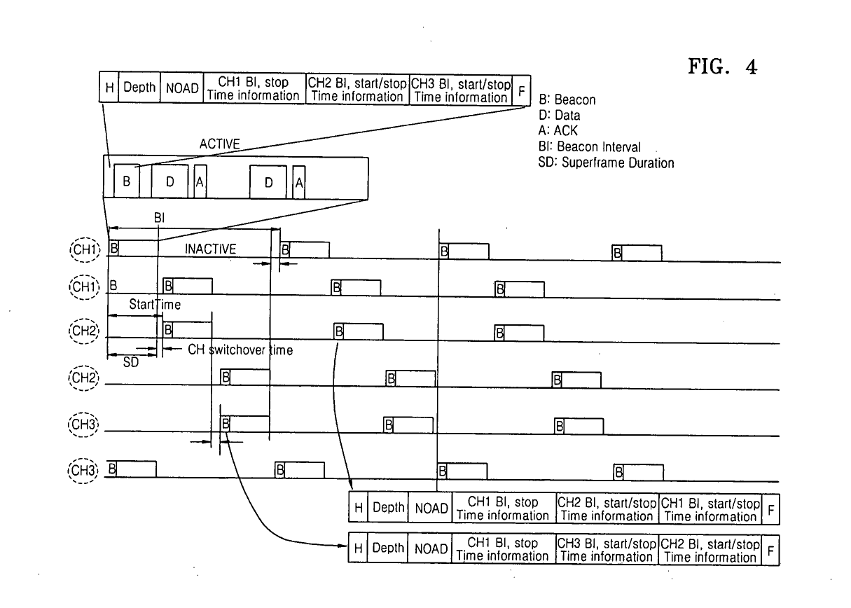

FIG. 4 is a flowchart illustrating a structure of a beacon in each channel, data types, such as Beacon, Data, or Ack, in an activated channel, and operations of multi-channels, according to an embodiment of the present invention.

Referring to FIG. 4, a devised MAC method is similar to a conventional institute of electrical and electronics engineers (IEEE) 802.15.4 Zigbee MAC method. That is, the devised MAC method uses a superframe that includes an active period in which nodes can transmit and receive data, and an inactive period in which nodes are in a sleep or standby mode to minimize power consumption. The active period includes a contention free period (CFP) used for real time traffic rt-traffic requiring assured service and a contention access period (CAP) used for non-real time traffic generally requiring the best efforts.

During an active period, nodes FFDs transmit beacons B, transmit data D, and receive Ack signals A.

Each beacon B includes a beacon payload field containing information regarding a depth, a NOAD, a BI and a stop time of a home channel, and BIs, start times, and stop times of other channels.

In FIG. 4, BI denotes an interval between beacons in the same channel. Start time denotes an activation start time of a channel. CH switchover time denotes a time required for a channel whose active period ends to switch to a next channel. SD denotes a superframe duration during which a channel continues to be active.

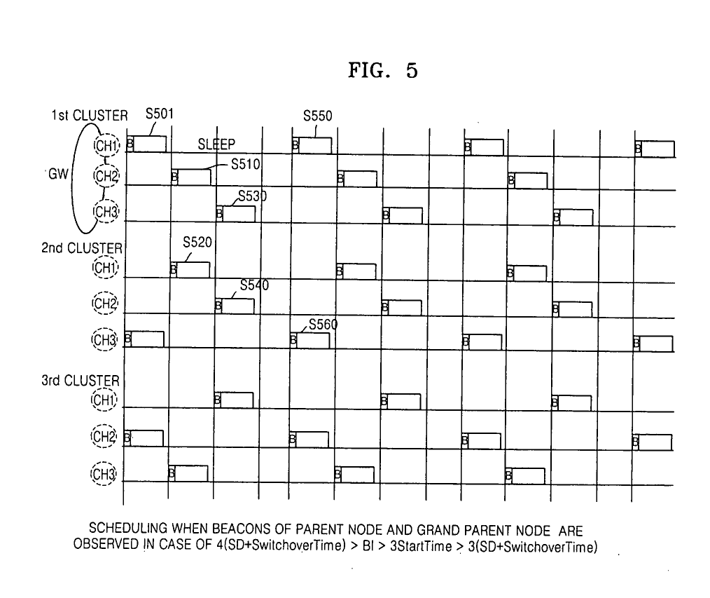

Flowcharts illustrating operations of multi-channels will now be explained in detail with reference to FIGS. 5 through 9.

FIGS. 5 through 9 are flowcharts illustrating operations of multi-channels according to embodiments of the present invention.

Referring to FIGS. 5 through 9, in operation S501, a GW generates and transmits a beacon to a first channel and serves nodes connected to the first channel in its area during an active period. In operation S510, the first channel enters a sleep mode, and the GW switches its RF to a second channel during a CH switchover time, transmits a beacon to the second channel, and serves nodes connected to the second channel in its area during an active period. In operation S520, member nodes of a second cluster of the first channel may be activated at the same time as the active period of the second channel according to their schedules through a beacon of a cluster header.

In operation S530, a third cluster of the first channel is activated during a sleep period of the second cluster of the first channel and a sleep period of the first cluster of the second channel. In operation S540, a second cluster of the second channel is activated at the same time as operation S530. All channels may be inactive when the second cluster of the second channel is in a sleep mode and the first cluster of the third channel is in a sleep mode until a BI timer of the first channel expires. In operation S550, the first cluster of the first channel is activated. In operation S560, a second cluster of the third channel is activated at the same time as operation S550. That is, the GW sequentially and repeatedly serves the first through third channels.

A scheduling relationship between incoming and outgoing beacons from the second cluster follows IEEE802.15.4-2006. Accordingly, when an FFD which cannot hear a grand parent beacon is designated as a coordinator, concurrency can be improved. If the FFD can hear a beacon from a grand parent, scheduling should be done so that the FFD is activated during a period other than an active period of the grand parent. That is, in FIG. 2, the device 12C should implement outgoing beacon scheduling so as to avoid an incoming beacon from the device 11C. If the FFD can also hear a beacon from the PNC through a first channel, there is no time when the FFD is activated while avoiding the two incoming beacons.

When three channels are operated and BI>SD,

4(SD+SwitchoverTime)>BI>3StartTime>3(SD+SwitchoverTime) (1).

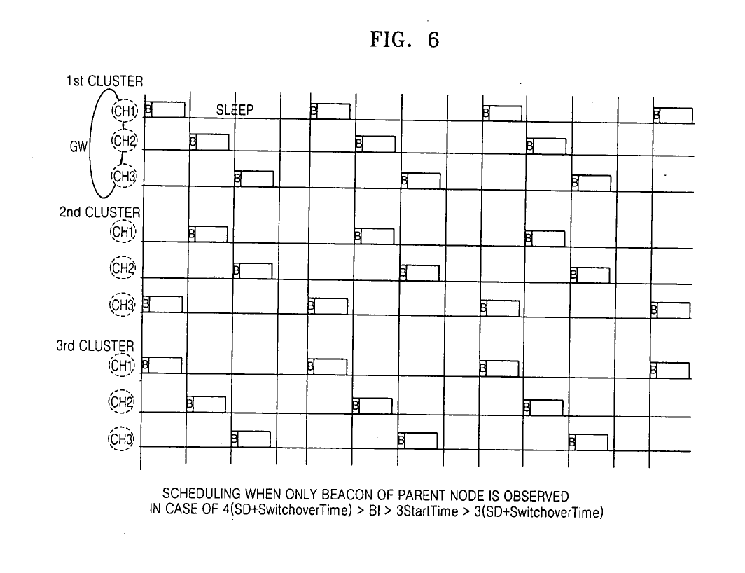

In relational expression 1, when a coordinator is located at a place where two beacons are observed, in order to operate with a concurrency of 3, scheduling should be done accurately so as to avoid active periods of a parent and a grand parent. When a coordinator is located at a place where a beacon of a grand parent is not observed, such scheduling, as shown in FIG. 6, is possible.

3StartTime>3(SD+SwitchoverTime)>BI>2StartTime>2(SD+SwitchoverTime) (2).

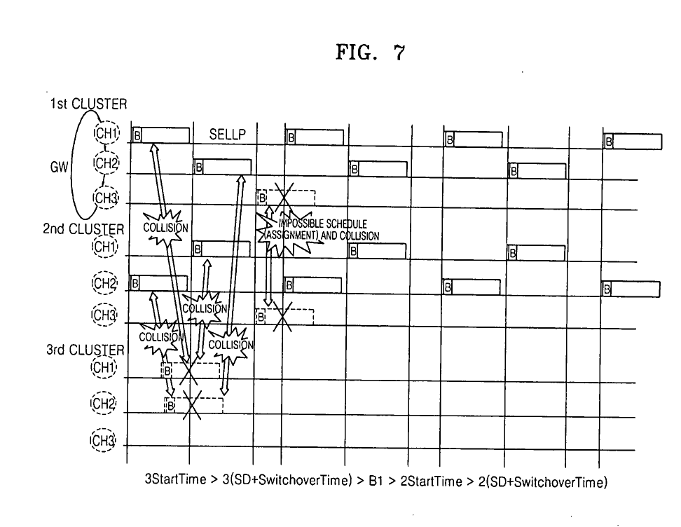

In relational expression 2, when a coordinator is located at a place where two beacons are observed, a third cluster member cannot be scheduled, as will be shown in FIG. 7.

BI>4StartTime>4(SD+SwitchoverTime) (3).

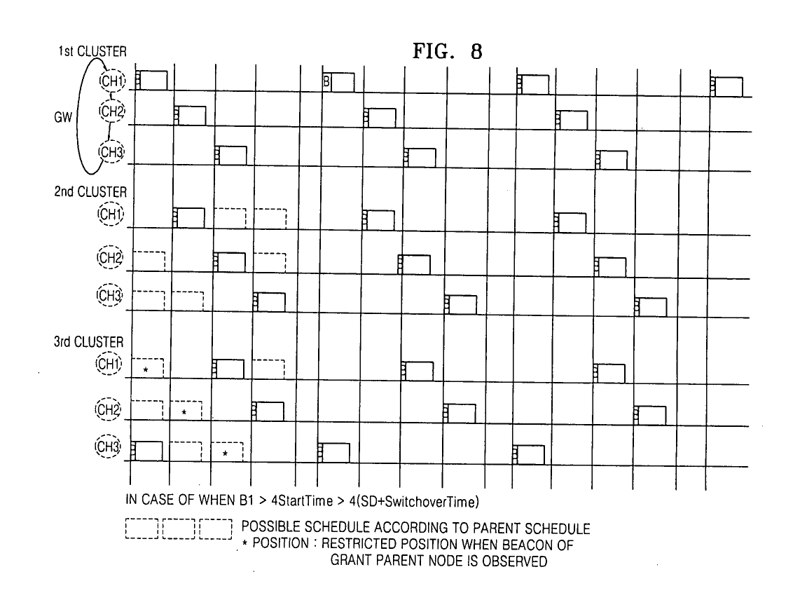

In relational expression 3, even when a coordinator is located at a place where two beacons are observed, the coordinator can operate with a concurrency of 3, as will be shown in FIG. 8.

That is, in order to increase concurrency, in the case of relational expressions 1 and 2, it is preferable that a next coordinator be located at a place other than a place where two or more beacons of a corresponding channel are observed, whereas in the case of relational expression 3, a next coordinator can be located at a place where two beacons are observed.

Accordingly, concurrency is achieved such that all observed incoming beacons and an outgoing beacon can be processed within limits.

(2) Operation of Auxiliary Channel When One Radio Interface is Used

Each of the clusters transmits data in a carrier sensor multiple access in a collision avoidance (CSMA/CA) mode during an active period of its home channel. However, when the cluster fails to transmit data during the active period of its home channel or needs to urgently transmit data, the cluster may wake up during an active period of its auxiliary channel and attempt to transmit data. Unless the auxiliary channel is used in this case, a delay time may be lengthened or data loss may be caused.

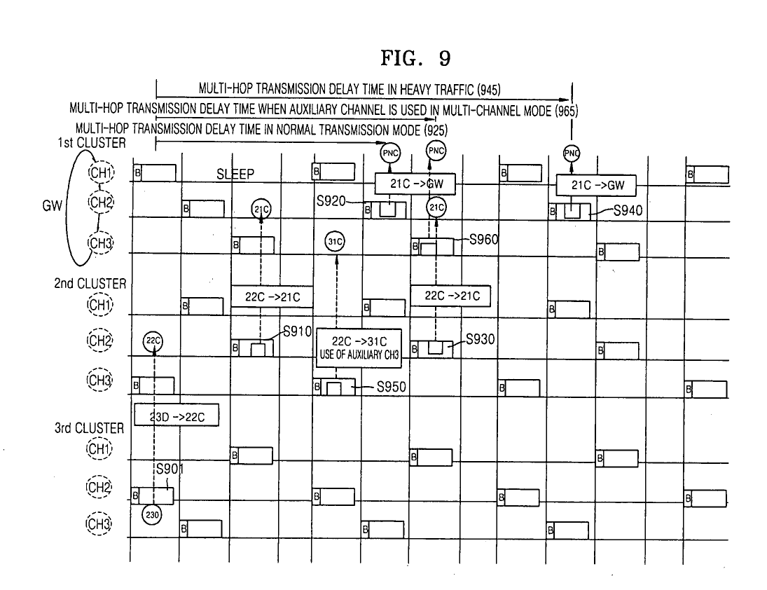

FIG. 9 is a flowchart illustrating operations of multi-channels according to an embodiment of the present invention.

Referring to FIG. 9, in a normal transmission mode, in operation S901, a node 23D which is a third cluster member transmits data to a node 22C during an active period of a second channel that is its home channel. In operation S910, the node 22C transmits the data to a node 21C during an active period of the second channel that is its home channel. In operation S920, the node 21C transmits the data to a GW during an active period of the second channel that is its home channel. Accordingly, in the normal transmission mode, a multi-hop transmission delay time turns out to be 925.

However, in a heavy upstream traffic mode, the node 22C fails to transmit the data in operation S910 and waits until a BI passes and its home channel is activated again. In operation S930, the node 22C transmits the data to the node 21C. In operation S940, the node 21C transmits the data to the GW when its home channel is activated. Accordingly, in the heavy upstream traffic mode, a multi-hop transmission delay time turns out to be 945.

On the other hand, even when the node 22C receiving the data from the node 23D fails to transmit the data in operation S910 due to heavy upstream traffic, the method may proceed to operation S950 instead of proceeding to operation S930 in which the node 22C waits until its home channel is activated. In operation S950, the node 22C transmits the data to a node 31C through a third channel that is its auxiliary channel when the third channel of a second cluster is activated. In operation S960, the node 31C transmits the data to the GW when its home channel is activated. Accordingly, when the auxiliary channel is used, a multi-hop transmission delay time turns out to be 965, which is shorter than the multi-hop transmission delay time of 945 in the heavy upstream traffic mode.

(3) Operation of Auxiliary Channel when Two Radio Interfaces are Used

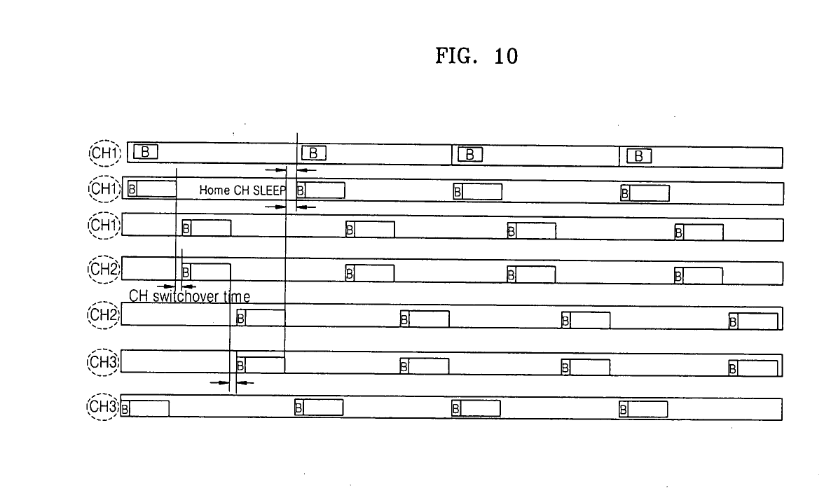

FIG. 10 is a flowchart illustrating operations of multi-channels according to another embodiment of the present invention.

Referring to FIG. 10, a coordinator transmits data through a radio interface using a home channel first of all when a home channel schedule allows. However, when there is heavy traffic, the home channel schedule does not allow, and the data needs to be urgently transmitted without loss, the coordinator transmits the data through a radio interface using a standby fourth channel that is an auxiliary channel of the home channel.

Because an uplink is usually problematical and power consumption of a GW is not problematical, a fourth channel receiver of the GW can be continuously turned on. Since the fourth channel receiver of the GW is opened all the time through the radio interface using the fourth channel, coordinators of a first cluster about the GW can access in an IEEE802.11 CSMA/CA mode.

A network using an auxiliary channel of the fourth channel below a second cluster may operate in an IEEE802.11 power saving mechanism (PSM) mode.

Also, a CH4 network through a radio interface_B uses a request to send frame-clear to send frame (RTS-CTS) in order to solve a hidden terminal problem that could occur in an IEEE802.11 network.

As described above, since one of two radio interfaces follows a multi-channel operating method, data can be simultaneously transmitted through a plurality of channels by changing channels so as to prevent interference, thereby improving transmission performance. Also, since an auxiliary channel is operated through another radio interface, transmission performance and reliability can be improved.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A coordinator in a wireless sensor network (WSN), the coordinator comprising:
a scan unit scanning a transmitted beacon and storing information on a channel included in the beacon;
a main radio interface communication unit, when it is determined that a home channel communicating with a parent node is in an inactive mode on the basis of the information on the channel, in synchronization with the activation of another channel of the same hierarchical level as that of the home channel, activating a home channel communicating with a child node, and communicating with the child node; and
an auxiliary radio interface communication unit communicating with the child node through an auxiliary channel that has a frequency band different from frequency bands of the home channel communicating with the child node and home channels of other nodes, and is always in an active mode.

2. The coordinator of claim 1, wherein, when the scan unit scans a beacon transmitted from a grand parent node and it is determined that a home channel through which the parent node communicates with the grand parent node is in an inactive mode on the basis of information on a channel included in the beacon transmitted from the grand parent node, in synchronization with the activation of another channel of the same hierarchical level as that of the home channel communicating with the parent node, the main radio interface communication unit activates the home channel communicating with the child node.

3. The coordinator of claim 1, wherein, when so heavy data is received that all the data cannot be transmitted to the parent node through the home channel communicating with the parent node, and a home channel through which another node of the same hierarchical level communicates with a parent node of the another node of the same hierarchical level is in an active mode, the main radio interface communication unit transmits the data entirely or partially through the home channel of the another node.

4. The coordinator of claim 1, wherein the auxiliary channel communication unit communicates through the auxiliary channel only when the child node is a full function device (FFD).

5. The coordinator of claim 1, wherein the auxiliary channel of the auxiliary channel communication unit operates in an institute of electrical and electronics engineers (IEEE) 802.11 carrier sensor multiple access in a collision avoidance (CSMA/CA) mode.

6. The coordinator of claim 1, wherein the auxiliary channel of the auxiliary channel communication unit operates in an IEEE 802.11 power saving mechanism (PSM) mode.

7. The coordinator of claim 1, wherein the auxiliary channel communication unit communicates with the child node through a request to send frame-clear to send frame (RTS-CTS).

8. A method of operating a coordinator in a WSN, the method comprising:
scanning a transmitted beacon and storing information on a channel included in the beacon;
when it is determined that a home channel communicating with a parent node is in an inactive mode on the basis of the information on the channel, in synchronization with the activation of another channel of the same hierarchical level as that of the home channel, activating a home channel communicating with a child node, and communicating with the child node; and
communicating with the child node through an auxiliary channel that has a frequency band different from those of the home channel communicating with the child node and home channels of other nodes and is always in an active mode.

9. The method of claim 8, wherein the activating of the home channel communicating with the child node comprises, when a beacon transmitted from a grand parent node is scanned and it is determined that a home channel through which the parent node communicates with the grand parent node is in an inactive mode on the basis of information on a channel included in the beacon transmitted from the grand parent node, in synchronization with the activation of another channel of the same hierarchical level as that of the home channel communicating with the parent node, activating the home channel communicating with the child node.

10. The method of claim 8, wherein the activating of the home channel communicating with the child node comprises, when so heavy data is received that all the data cannot be transmitted to the parent node through the home channel communicating with the parent node, and a home channel through which another node of the same hierarchical level communicates with a parent node of the another node of the same hierarchical level is in an active mode, entirely or partially transmitting the data through the home channel of the another node.

11. The method of claim 8, wherein the communicating with the child node comprises communicating with the child node through the auxiliary channel only when the child node is a FFD.

12. The method of claim 8, wherein the communicating with the child node comprises operating the auxiliary channel in an IEEE 802.11 CSMA/CA mode.

13. The method of claim 8, wherein the communicating with the child node comprises operating the auxiliary channel in an IEEE 802.11 PSM mode.

14. The method of claim 8, wherein the communicating with the child node comprises communicating with the child node through an RTS-CTS.
